(19) United States
(12) Patent Application Publication
(10) Pub. No.: US 2007/0094029 A1
(43) Pub. Date: Apr. 26, 2007

(54) Speech synthesis method and information providing apparatus

(76) Inventors: Natsuki Saito, Osaka (JP); Takahiro Kamai, Kyoto (JP); Yumiko Kato, Osaka (JP); Yoshifumi Hirose, Kyoto (JP)

Correspondence Address: WENDEROTH, LIND & PONACK L.L.P., 2033 K. STREET, NW, SUITE 800, WASHINGTON, DC, 20006, US

(21) Appl. No.: 11/434,153

(22) Filed: May 16, 2006

Related U.S. Application Data
(63) Continuation of application No. PCT/JP05/22391, filed on Dec. 6, 2005.

(30) Foreign Application Priority Data
Dec. 28, 2004 (JP) 2004-379154

(51) Int. Cl. G10L 13/08

(52) U.S. Cl. 704/260

(57) ABSTRACT

To provide a speech synthesis method of reading out units of synthesized speech without fail and in an easy to understand manner, even when playback of the units of synthesized speech are simultaneously requested. The duration prediction unit predicts the playback duration of synthesized speech to be synthesized based on text. The time constraint satisfaction judgment unit judges whether a constraint condition concerning the playback timing of the synthesized speech is satisfied or not, based on the predicted playback duration. If it judged that the constraint condition is not satisfied, the content modification unit shifts the playback starting timing of the synthesized speech of the text forward or backward, and modifies the contents of the text indicating time and distance in accordance with the shifted time. The synthesized speech generation unit generates synthesized speech based on the text having the modified contents and plays it back.

### CROSS REFERENCE TO RELATED APPLICATION

This is a continuation application of PCT application No. PCT/JP2005/022391 filed Dec. 6, 2005, designating the United States of America.

### BACKGROUND OF THE INVENTION

(1) Field of the Invention

The present invention relates to a speech synthesis method of reading out synthesized speech contents with a constraint in playback timing without fail and a speech synthesis apparatus which executes the method.

(2) Description of the Related Art

There has been conventionally provided a speech synthesis apparatus which generates a synthesized speech corresponding to desired text and outputs the generated synthesized speech. There are various applications of an apparatus which provides a user with speech information by causing a speech synthesis apparatus to read out a sentence which has been automatically selected in a memory in accordance with a situation. Such apparatus is, for example, used in a car navigation system. The apparatus informs a user of junction information several hundred meters before the junction, or receives traffic congestion information and provides the user with the information, based on information such as a present position, a running speed of a car and a preset navigation route.

In these applications, it is difficult to determine in advance a playback timing of all synthesized speech contents. In addition, it may become necessary to read out new text at a timing which cannot be predicted in advance. Here is an example case where a user must turn at a junction and receives information concerning a traffic congestion ahead of the junction just before arriving at the junction. In this case, it is required to provide the user with both the route navigation information and the traffic congestion information in an easy to understand manner. Techniques for this purpose include Patent References 1 to 4.

In the methods of Patent References 1 and 2, speech contents to be provided are given priorities in advance. In the case where plural speech contents are required to be read out at the same time, the contents with a higher priority is played back and the contents with a lower priority is controlled so as not to be played back. The Patent Reference 1 is Japanese Laid-Open Patent Application No. 60-128587, and the Patent Reference 2 is Japanese Laid-Open Patent Application No. 2002-236029.

The method of Patent Reference 3 is intended for satisfying the constraint condition concerning a playback duration using a method of reducing a silent part of synthesized speech. In the method of Patent Reference 4, a compression rate of a document is dynamically changed in response to a change in environment, and the document is summarized according to the compression rate. The Patent Reference 3 is Japanese Laid-Open Patent Application No. 6-67685, and the Patent Reference 4 is Japanese Laid-Open Patent Application No. 2004-326877.

However, in the conventional method, text which should be read out using speech is stored as templates. Thus, in the case where it becomes necessary to play back two units of speech at the same time, available methods only include: canceling playback of one of the units of speech; playing back one of the units of speech later on; and compressing a large amount of information in a short duration by increasing playback speeds. Among these methods, in the method of preferentially playing back one of the units of speech, a problem occurs if both of the units of speech are given equivalent priorities. In addition, in the method of using forwarding or compressing of speech, there occurs a problem that the speech becomes difficult to be heard. In addition, in the method of Patent Reference 4, a document before being outputted is summarized by reducing the number of characters in the document. If the compression rate of a document becomes high, in the summarization method like this, a lot of characters in the document are deleted. This causes a problem that it becomes difficult to communicate the contents of the document after being summarized in an easy to understand manner.

### SUMMARY OF THE INVENTION

The present invention has been conceived considering these problems. An object of the present invention is to provide a user with information as much as possible maintaining listenability of speech, modifying the contents of text to be read out in accordance with a temporal constraint condition.

In order to achieve the above-mentioned object, the speech synthesis method of the present invention includes: predicting the playback duration of synthesized speech to be generated based on text; judging whether a constraint condition concerning the playback timing of the synthesized speech is satisfied or not, based on the predicted playback duration; in the case where the judging shows that the constraint condition is not satisfied, shifting the playback starting timing of the synthesized speech of the text forward or backward, and modifying the contents indicating time or distance in the text, in accordance with the duration by which the playback starting timing of the synthesized speech is shifted; and generating synthesized speech based on the text with the modified contents, and playing back the synthesized speech. Accordingly, with the present invention, in the case where it is judged that a constraint condition relating to the playback timing of a synthesized speech is not satisfied, the playback starting timing of the synthesized speech of the text is shifted forward or backward, and the text contents indicating time or distance is modified in accordance with the shifted time. Therefore, even in the case of playing back the synthesized speech at a shifted timing, there is an effect that it is possible to inform the user of the contents (time and distance) which change as time passes without changing the essential contents of the original text.

In addition, in the case where there are plural units of speech in the speech synthesis method, the predicting may include predicting the playback duration of second synthesized speech. The playback of the second synthesized speech needs to be completed before the playback of first synthesized speech starts. The judging may include judging that the constraint condition is not satisfied, in the case where the predicted playback duration of the second synthesized speech indicates that the playback of the second synthesized speech is not completed before the playback of the first synthesized speech starts. The shifting may include delaying the playback starting timing of the first synthesized speech to a predicted playback completion time of the second synthesized speech. The modifying may include modifying the contents of text based on which the first synthesized speech is generated. The shifting and modifying are performed in the case where the judging shows that the constraint condition is not satisfied. The generating may include generating synthesized speech based on the text with the modified contents and playing back the synthesized speech, after completing the playback of the second synthesized speech. Accordingly, with the present invention, it is possible to delay the playback starting timing of the first synthesized speech so that the first synthesized speech and the second synthesized speech are not simultaneously played back. Further, it is possible to modify the contents indicating time and distance shown in the original text based on which the first synthesized speech is generated, in accordance with the delay of the playback starting timing of the first synthesized speech. This makes it possible to provide effects of playing back both of the first synthesized speech and the second synthesized speech and inform the user of the essential contents which the text indicates.

In addition, in the speech synthesis method, the modifying may further include reducing the playback duration of the second synthesized speech by summarizing the text based on which the second synthesized speech is generated, and delaying the playback starting timing of the first synthesized speech to a time at which the playback of the second synthesized speech with the reduced playback duration is completed. This makes it possible to provide effects of shortening the duration by which the playback starting timing of the first synthesized speech is delayed or eliminating the necessity of delaying the playback starting timing of the first synthesized speech.

The present invention can be realized as not only a speech synthesis apparatus like this. It should be noted that the present invention can be realized as a speech synthesis method which is made up of steps corresponding to unique units included in the speech synthesis apparatus and a program which causes a computer to execute these steps. Of course, the program can be distributed through a recording medium such as a CD-ROM and a communication medium such as the Internet.

Even in the case where a schedule which needs to be read out by a predetermined time cannot be read out by the time for some reason, the speech synthesis apparatus of the present invention can change the reading-out time and then read out the schedule, on condition that the schedule is not yet to be started. In addition, in the case where there arises a necessity of playing back units of synthesized speech, it provides an effect of making it possible to play back the contents of the units of synthesized speech within a limited duration without failing to play back any units of speech, using an approach of modifying the contents of the synthesized speech and a playback start time. In the case where only the playback start time of the units of synthesized speech is simply changed, the contents which change as time passes, to be more specific, the (scheduled) time, the (moving) distance and the like become different from the essential contents. In contrast, in the present invention, speech is synthesized and played back after text contents indicating the time and distance are modified in accordance with the change of the playback start time of the synthesized speech. Therefore, the present invention can provide an effect of making it possible to play back the essential text contents correctly.

### FURTHER INFORMATION ABOUT TECHNICAL BACKGROUND TO THIS APPLICATION

The disclosure of Japanese Patent Application No. 2004-379154 filed on Dec. 28, 2004 including specification, drawings and claims is incorporated herein by reference in its entirety.

The disclosure of PCT application No. PCT/JP2005/022391 filed, Dec. 6, 2005, designating the United States of America, including specification, drawings and claims is incorporated herein by reference in its entirety.

### BRIEF DESCRIPTION OF THE DRAWINGS

These and other objects, advantages and features of the invention will become apparent from the following description thereof taken in congestion with the accompanying drawings that illustrate a specific embodiment of the invention. In the Drawings:

FIG. 1 is a diagram showing the configuration of the speech synthesis apparatus of a first embodiment of the present invention;

FIG. 2 is a flow chart showing an operation of the speech synthesis apparatus of the first embodiment of the present invention;

FIG. 3 is an illustration indicating a data flow into a constraint satisfaction judgment unit;

FIG. 4 is an illustration indicating a data flow concerning a content modification unit;

FIG. 5 is an illustration indicating a data flow concerning a content modification unit;

FIG. 6 is a diagram showing the configuration of the speech synthesis apparatus of a second embodiment of the present invention;

FIG. 7 is a flow chart showing an operation of the speech synthesis apparatus of the second embodiment of the present invention;

FIG. 8A and 8B each is an illustration showing a state where new text is provided during the playback of synthesized speech;

FIG. 9 is an illustration indicating a state of processing relating to a waveform playback buffer;

FIG. 10A is an illustration indicating a sample of label information;

FIG. 10B is an illustration indicating a playback position pointer;

FIG. 10C is an illustration indicating a sample of modified label information;

FIG. 11 is a diagram showing the configuration of the speech synthesis apparatus of a third embodiment of the present invention; and

FIG. 12 is a flow chart showing an operation of the speech synthesis apparatus of the third embodiment of the present invention.

### DESCRIPTION OF THE PREFERRED EMBODIMENT(S)

Embodiments of the present invention will be described below in detail with reference to figures.

### First Embodiment

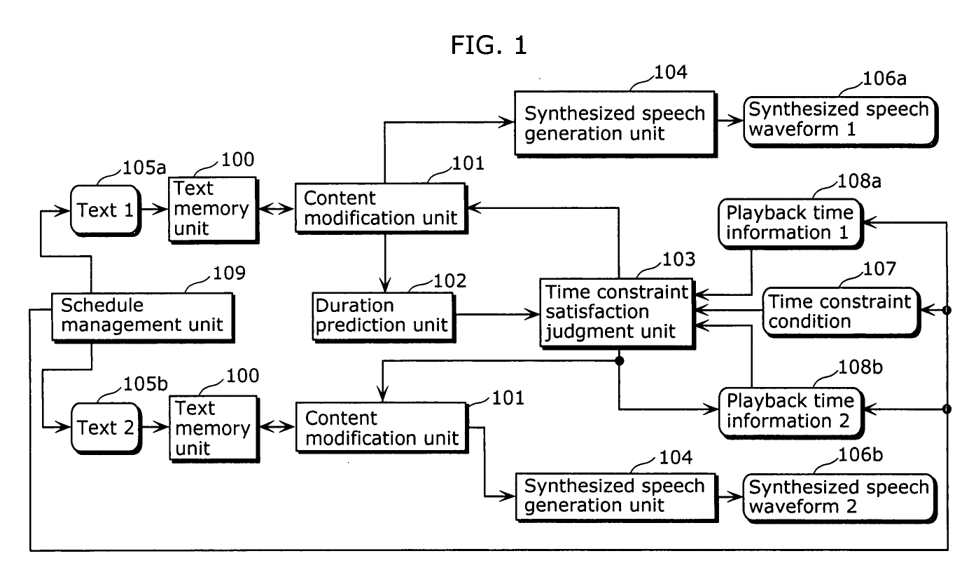

FIG. 1 is a diagram showing the configuration of a speech synthesis apparatus of a first embodiment of the present invention.

The speech synthesis apparatus of the embodiment is intended for judging whether or not there is an overlap in playback time of two units of text 105a and 105b to be inputted at the time of generating synthesized speech of the text and playing back each synthesized speech. It is also intended for resolving an overlap in playback time of units of text by summarizing the contents of the text and changing the playback timings, in the case where there is an overlap. The speech synthesis apparatus includes: a text memory unit 100, a duration prediction unit 102, a time constraint satisfaction judgment unit 103, a synthesized speech generation unit 104, and a schedule management unit 109. The text memory unit 100 stores text 105a and 105b inputted from the schedule management unit 109. The content modification unit 101 has a function defined in the Claim reading “content modification unit operable to shift the playback starting timing of the synthesized speech of the text forward or backward, and modify contents of the text indicating time or distance, in accordance with the shifted duration, in the case where said time constraint satisfaction judgment unit judges that the constraint condition is not satisfied”. The content modification unit 101 reads out the text 105a and 105b from the text memory unit 100 according to the judgment by the time constraint satisfaction judgment unit 103 and summarizes the read-out text 105a and 105b. In addition, it modifies the contents indicating time or distance included in the text 105a and 105b, when the playback timing of the synthesized speech is modified, in accordance with the shifted time (changed playback timing). The duration prediction unit 102 has a function defined in the Claim reading “predicting a playback duration of synthesized speech to be generated based on text”. It predicts the playback duration at the time of generating synthesized speech of text 105a and 105b outputted from the content modification unit 101. The time constraint satisfaction judgment unit 103 has a function defined in the Claim reading “judging whether a constraint condition concerning a playback starting timing of the synthesized speech is satisfied or not, based on the predicted playback duration”. It judges whether or not the constraint relating to the playback time (playback timing) and the playback duration of the synthesized speech to be generated, based on the playback duration predicted by the duration prediction unit 102 and the time constraint condition 107 and the playback time information 108a and 108b inputted from the schedule management unit 109. The synthesized speech generation unit 104 has a function defined in the Claim reading “generating synthesized speech based on the text with the modified contents, and playing back the synthesized speech”. It generates synthesized speech waveforms 106a and 106b from the text 105a and 105b inputted through the content modification unit 101. The schedule management unit 109 calls the schedule information which has been preset through an input by a user according to time, generates text 105a and 105b, a time constraint condition 107 and playback time information 108a and 108b, and causes the synthesized speech generation unit 104 to play back the units of synthesized speech. The time constraint satisfaction judgment unit 103 judges an overlap in playback time of the units of synthesized speech, based on the playback time information 108a and 108b of the two synthesized speech waveforms 106a and 106b, the resulting predicted duration of the text 101a obtained from the duration prediction unit 102, and the time constraint conditions 107 which should be satisfied. Note that it is assumed that the text 105a and 105b are sorted in advance in the text memory unit 100 by the schedule management unit 109 in an order of playback start time, and further the playback priority order is the same, in other words, the text 105a is always played back before the text 105b.

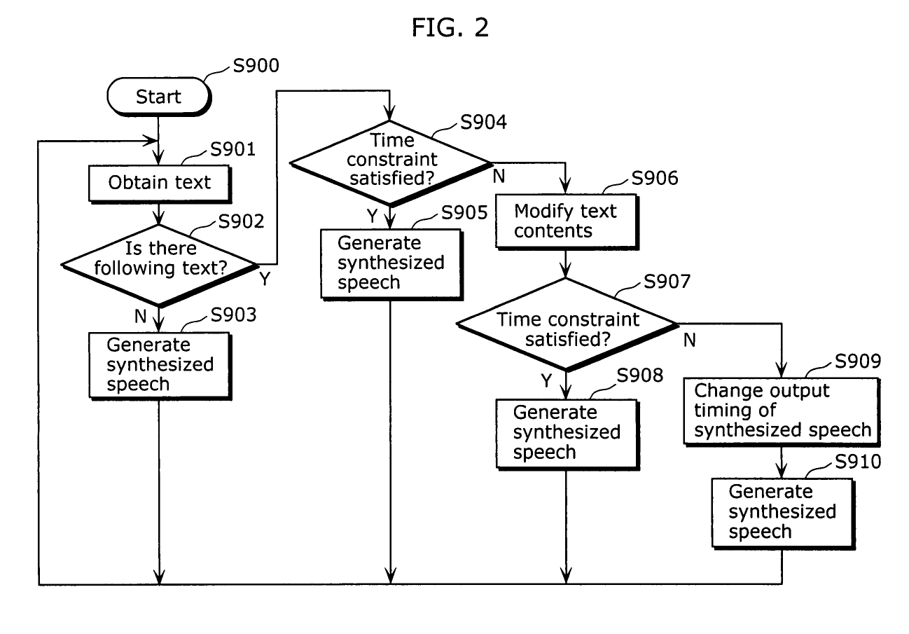

FIG. 2 is a flow chart indicating an operation flow of the speech synthesis apparatus of this embodiment. The operation will be described below according to the flow chart of FIG. 2.

The operation starts in an initial state of S900. First, the text memory unit 100 obtains the text (S901). The content modification unit 101 judges whether or not there is only a single unit of text and there is no following text (S902). In the case where there is no such text, the synthesized speech generation unit 104 performs speech synthesis of the text (S903), and waits for the next text to be inputted.

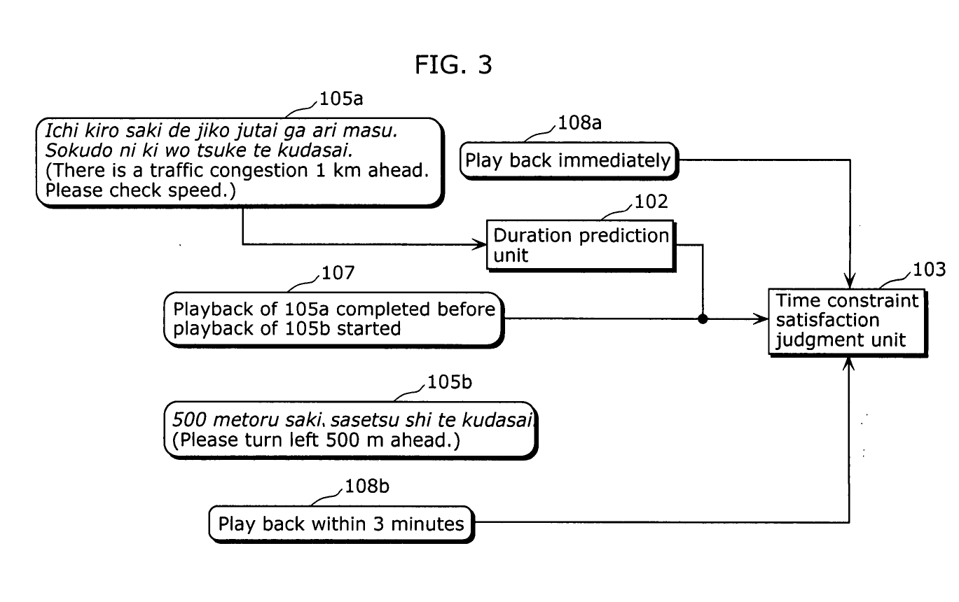

In the case where there is such following text, the time constraint satisfaction judgment unit 103 judges whether or not the time constraint is satisfied (S904). FIG. 3 shows the data flow into the time constraint satisfaction judgment unit 103. In FIG. 3, the text 105a is sentences of “Ichi kiro saki de jiko jutai ga ari masu. Sokudo ni ki wo tsuke te kudasai. (There is a traffic congestion 1 km ahead. Please check speed.)”, and the text 105b is a sentence of “500 metoru saki, sasetsu shi te kudasai. (Please turn left 500 m ahead.”. The time constraint condition 107 is intended for “completing playback of the text 105a before the playback of the text 105b starts” so that the playback time of the text 105a and 105b are not overlapped with each other. On the other hand, it is necessary that the text 105a needs to be played back immediately according to the playback time information 108a, and the text 105b needs to be played back within 3 seconds according to the playback time information 108b. The time constraint satisfaction judgment unit 103 may obtain the predicted value of the playback duration obtained at the time when the duration prediction unit 102 performed the speech synthesis of the text 105a, and judge whether the predicted value is within 3 seconds or not. In the case where the predicted value of the playback duration of the text 105a is within 3 seconds, the text 105a and 105b are subjected to speech synthesis and outputted without any modification (S905).

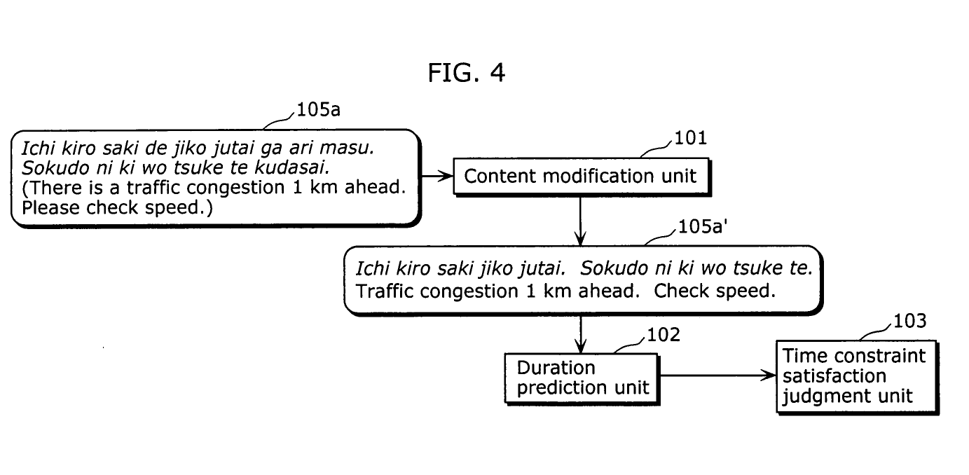

FIG. 4 is an illustration showing a data flow concerning the content modification unit 101 at the time when the predicted value of the playback duration of the text 105a is within 3 seconds, and the time constraint satisfaction judgment unit 103 judged that the time constraint condition 107 is not satisfied.

In the case where the time constraint condition 107 is not satisfied, the time constraint satisfaction judgment unit 103 instructs the content modification unit 101 to summarize the contents of the text 105a (S906). In FIG. 4, a summarized sentence of text 105a′ reading “Ichi kiro saki jiko jutai. Sokudo ni ki wo tsuke te. (A traffic congestion 1 km ahead. Check speed.)” is obtained from the sentence of text 105a reading “Ichi kiro saki de jiko jutai ga ari masu. Sokudo ni ki wo tsuke te kudasai. (There is a traffic congestion 1 km ahead. Please check speed.)”. Any method may be used as a concrete summarization method. For example, it is good to measure the importance of each word in a sentence using an indicator of “tf*idf”, and to delete, in a sentence, a clause including a word with a value which does not exceed a proper threshold value. The indicator “tf*idf” is widely used for measuring the importance of each word appearing in a document. A value of “tf*idf” is obtained by multiplying the term frequency tf of each word in the document with the inverse document frequency where the word appears. A greater value indicates that the word appears frequently only in the document, and thus it is possible to judge that the importance of the word is high. This summarization method are disclosed in: “Jido kakutokushita gengo patan wo mochiita juuyoubun chuushutsu shisutemu (Summarization by Sentence Extraction using Automatically Acquired Linguistic Patterns)” published in the proceedings of the 8th Annual Meeting of the Association for Natural Language Processing, pp. 539 to 542, written by Chikashi Nobata, Satoshi Sekine, Hitoshi Isahara and Ralph Grishman; and, Japanese Laid-Open Patent Application No. 11-282881 and the like, and hence a detailed description of the method is not provided here.

The duration prediction unit 102 re-obtains a predicted value of the playback duration of the summarized sentence 105′a obtained in this way. The time constraint satisfaction judgment unit 103 obtains the predicted value and judges whether the constraint is satisfied or not (S907). In the case where the constraint is satisfied, it is good that the synthesized speech generation unit 104 performs speech synthesis of the summarized sentence 105′a so as to generate a synthesized speech waveform 106a and plays back the generated synthesized speech waveform 106a, and that it performs speech synthesis of the summarized sentence 105b so as to generate a synthesized speech waveform 106b and plays back the generated synthesized speech waveform 106b (S908).

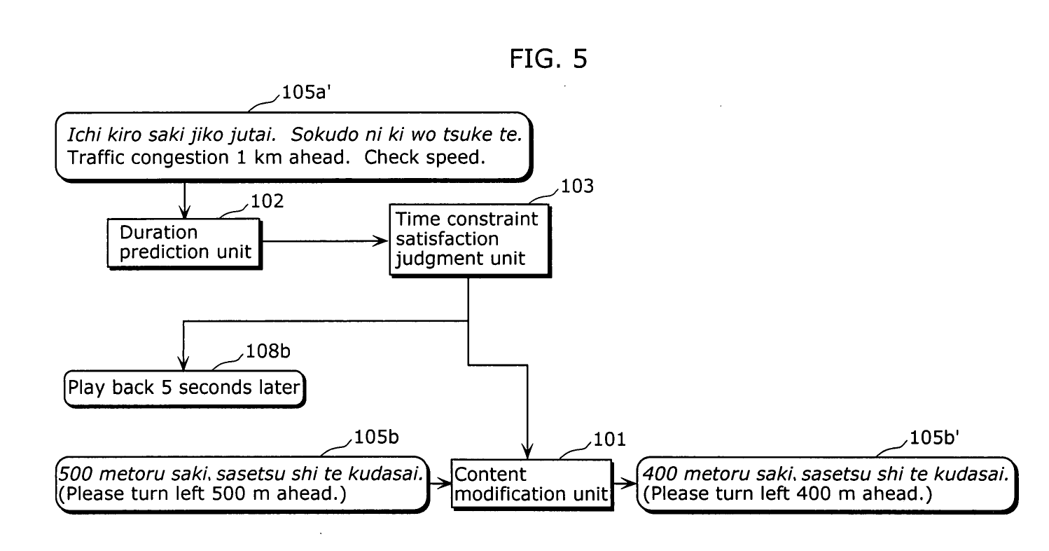

FIG. 5 is an illustration showing a data flow concerning the content modification unit 101 at the time when the predicted value of the playback duration of the summarized sentence 105a′ also exceeds 3 seconds, and the time constraint satisfaction judgment unit 103 judged that the time constraint condition 107 is not satisfied.

In the case where even the summarized sentence 105a′ does not satisfy the time constraint condition 107, the time constraint satisfaction judgment unit 103 changes the output timing of the synthesized speech waveform 106b (S909). For example, it delays the playback start time of the synthesized speech waveform 106b. In other words, in the case where the predicted value of the playback duration of the summarized sentence 105a′ is 5 seconds, it modifies the playback time information 108b so as to indicate “5-second-later playback”, and then instructs the content modification unit 101 to modify the text 105b accordingly. In this case, in the case where a calculation based on a present running speed of a car shows that the car moves 100 meters ahead in 5 seconds, it generates the text 105b′ of “400 metoru saki, sasetsu shite kudasai. (Please turn left 400 ahead.)”. In the case where it becomes possible to satisfy the time constraint condition 107 by further summarizing the contents of the text 105b without changing the playback time of the synthesized speech waveform 106b, the time constraint satisfaction judgment unit 103 may perform such processing. Further, here is an example case where there is room for advancing the playback time of the synthesized speech waveform 106a by, for example, “2 seconds” and the playback time information 108a of the synthesized speech waveform 106a indicates “2-second-later playback” instead of indicating “immediate playback”. In this case, the speech synthesis apparatus may satisfy the time constraint condition 107 by advancing the playback time of the synthesized speech waveform 106a. It performs speech synthesis of the text 105b′ generated in this way using the synthesized speech generation unit 104, and outputs the synthesized speech (S910).

The use of the above-described method makes it possible to play back both of the two synthesized speech contents within a limited time without changing the meanings, even in the case where both of the synthesized speech contents need to be played back at the same time. In particular, in the case of a car navigation apparatus mounted on a car, there frequently arises a necessity of providing a speech guidance such as traffic congestion information at an unpredictable timing even when a route guidance using speech is being provided. In preparation to this, the speech synthesis apparatus of the present invention instructs the content modification unit 101 to modify the contents indicating time and distance in the text 105b in accordance with the output timing shift, and causes the synthesized speech generation unit 104 to change the output timing of the synthesized speech waveform 106b. Such contents include contents concerning a running distance of a car. More specifically, here is a case where the content modification unit 101 should play back the synthesized speech of the text 105b of “500 metoru saki, sasetsu shite kudasai. (Please turn left 500 m ahead.)” at a timing and it plays back the synthesized speech 2 seconds later. In this case, the content modification unit 101 obtains the running speed of a car based on a value indicated by speed meter and calculates the distance from the present running speed of the car. In the case where the calculation result showed that the car will advance 100 meters ahead in 2 seconds, the content modification unit 101 generates text 105b′ of “400 metoru saki, sasetsu shite kudasai. (Please turn left 400 ahead.)”. This enables the synthesized speech generation unit 104 to output the synthesized speech indicating the essentially same meaning as the text 105b, even in the case where the playback timing lags behind by 2 seconds. In the case where the number of characters is drastically reduced through summarization, the meaning of the contents tends to become difficult to be heard correctly by a user. However, in the case where the speech synthesis apparatus of the present invention is incorporated in a car navigation apparatus, there is an effect that the speech synthesis apparatus controls such a problem and can provide a guidance with which a user can hear the essential meaning of the text more correctly.

It is assumed that all the units of inputted text have the same playback priority in this embodiment. However, in the case where each unit of text has a different playback priority, note that it is good to perform such processing after resorting the units of text according to the priority order. For example, it resorts the text with a high priority and the text with a low priority as text 105a and text 105b respectively at the stage immediately after it obtained the text (S901), and performs the following processing in a same manner. Further, it may start to play back the text with a high priority at a predetermined playback start time without summarizing the text with a high priority. In addition, it may reduce the playback time of the text with a low priority by summarizing it, or advance or delay the playback start time of it. In addition, it may suspend the reading-out of the text with a low priority, read out the synthesized speech of the text with a high priority, and then restarts to read out the text with a low priority.

An application to a car navigation system is taken as an example in the description in this embodiment. However, the method of the present invention can be generally used for applications where units of synthesized speech with a preset constraint condition in playback time are played back at the same time.

Here is an example of a synthesized speech announcement which is provided inside a route bus. By the announcement, advertisements are distributed and a guidance concerning bus stops is provided. Here, such guidance is “Tsugi wa, X teiryusho, X teiryusho desu. (Next bus stop is X, X.) ”, such advertisement is “Shoni ka nai ka no Y uin wa kono teiryusho de ori te toho 2 fun desu. (Y hospital of pediatrics and internal medicine is two minutes' walk from this bus stop.)”, and the advertisement is tried to be read out after the guidance is played back. In the case where the bus arrives at the bus stop X before completing reading out the advertisement, it may summarize the guidance as “Tsugi wa, X teiryusho desu. (Next bus stop is X.) ” so as to shorten the guidance. If the summarization is still not enough, it may summarize the advertisement as “Y uin wa kono teiryusho desu. (Y hospital is near this bus stop.)”.

In addition to the above example, the present invention can be applied to a scheduler which reads out a schedule registered by a user using synthesized speech at a preset time. Here is an example where a scheduler has been set to provide a guidance informing that a meeting starts 10 minutes later using a synthesized speech. In the case where a user boots up another application and starts work using the application before the reading-out of the guidance starts, the scheduler cannot provide the speech guidance until the time the user completes the work, for example until 3 or 4 minutes passes. Note that the time at which the schedule is to be read out needs to be preset so that the schedule can be read out before the meeting starts. In this case, if there is no trouble, the content modification unit 101 would play back the synthesized speech of “10 pun go nimiitingu ga hajimarimasu. (The meeting will start 10 minutes later.)”. However, applying the present invention to the scheduler makes it possible to delay the playback of the speech to 5 minutes before the meeting starts, because 3 or 4 minutes has passed due to the immediately-before work, generate modified synthesized speech text by modifying “10 minutes later” into “5 minutes later”, and read out the modified synthesized speech of “5 fun go ni miitingu ga hajimari masu. (The meeting will start 5 minutes later.)”. Accordingly, even in the case where a schedule registered by a user cannot be read out at a preset time, applying the present invention to the scheduler makes it possible to change the scheduled time (for example, “10 minutes later”) indicated by the registered schedule by the delay of a reading-out timing (for example, 5 minutes), and to read out the contents indicating the same scheduled time (for example, “5 minutes later”) as the registered schedule, even when the reading-out timing is delayed (for example, by 5 minutes). In other words, the present invention provides an effect that it can read out the essential contents of the schedule correctly, even in the case where the reading-out timing of the schedule is shifted.

Here has been described a case of completing reading out the schedule (meeting schedule) before the start time of the meeting. However, the present invention is not limited to this case. For example, the scheduler may read out the schedule after the meeting has started, on condition that it is within the time range that has been registered by the user in advance. Here is an example case where the user has registered a setting of “reading the schedule even in the case where the scheduled time of the schedule has passed, on condition that the timing shift is within 5 minutes”. It is assumed that the user has set the reading-out time of the schedule as 10 minutes before the meeting, but, for some reason, 13 minutes has passed from the preset reading-out time by the time at which the scheduler is allowed to read out the schedule. Even in this case, the scheduler of the present invention can read out the synthesized speech of “Miiting wa 3 pun mae ni hajima tte imasu. (The meeting has started 3 minutes before.)”.

Second Embodiment

In the first embodiment, in the case where the playback timing of the synthesized speech to be played back first and the playback timing of the synthesized speech to be played back later are overlapped with each other, the text of the synthesized speech to be played back first is summarized so as to reduce the playback duration. Additionally, the playback start time of the synthesized speech is delayed in the case where the playback of the summarized synthesized speech which is firstly played back is not completed by the time at which the playback of the synthesized speech to be played back immediately next starts. On the other hand, in a second embodiment, the first text and the second text are connected to each other first, and then the connected text is subjected to content modification. More specific case will be described below. It is the case where a part of the synthesized speech waveform 106a, which has been synthesized based on the first text which is played back first, has already been played back.

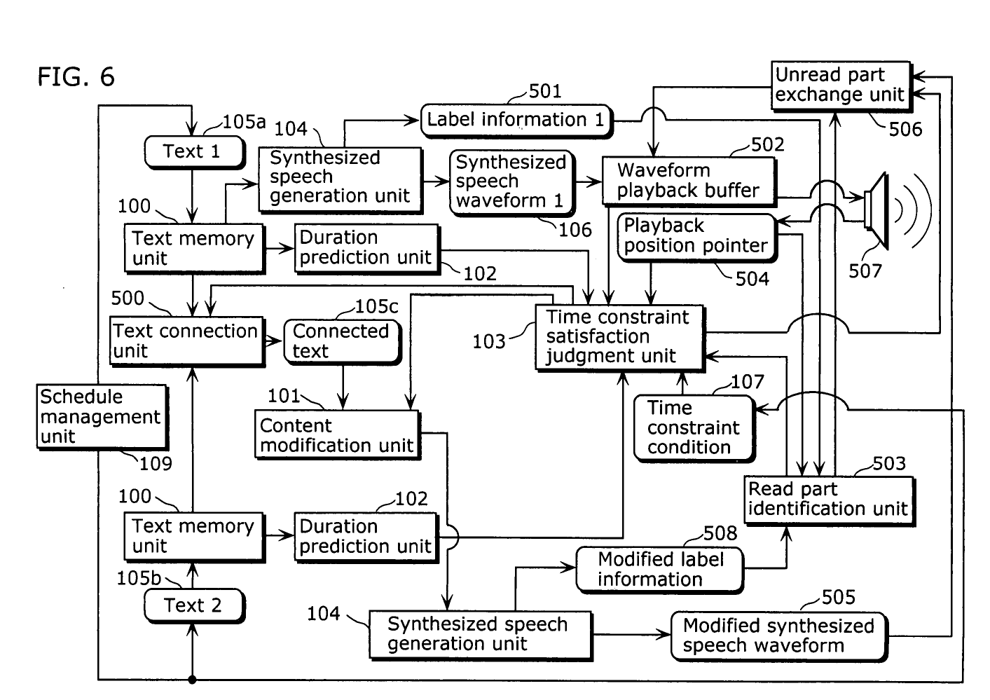

FIG. 6 is a diagram of a configuration showing the speech synthesis apparatus of the second embodiment of the present invention.

The speech synthesis apparatus of this embodiment is intended for handling the following situation: the second text 105b is provided after the playback of the first text 105a to be inputted is started; and a time constraint condition 107 cannot be satisfied even in the case where the second text 105b is subjected to speech synthesis and played back after the playback of the synthesized speech waveform 106a of the first text 105a is completed. Compared with the configuration shown in FIG. 1, the configuration of FIG. 6 include: a text connection unit 500 which connects the text 105a and 105b stored in the text memory unit 100 so as to generate a single text 105c; a speaker 507 which plays back the generated synthesized speech waveform; a waveform playback buffer 502 which refers to the synthesized speech waveform data played back by the speaker 507; a playback position pointer 504 which indicates the time position in the waveform playback buffer 502 currently played back by the speaker 507; label information 501 of the synthesized speech waveform 106 and label information 508 of the synthesized speech waveform 505 which can be generated by the synthesized speech generation unit 104; a read part identification unit 503 which associates the read part in the waveform playback buffer 502 with the position in the synthesized speech waveform 505, with reference to the playback position pointer 504; and an unread part exchange unit 506 which replaces the unread part of the waveform playback buffer 502 by the part corresponding to the synthesized speech waveform 505 and the following part.

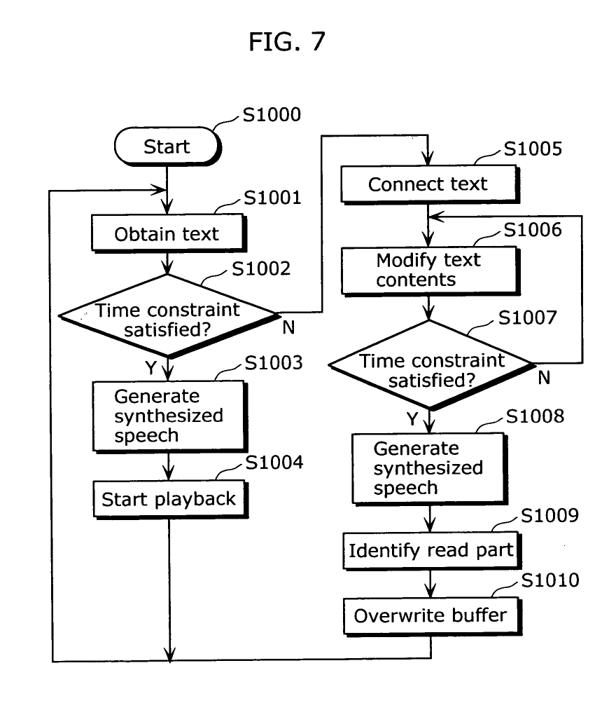

FIG. 7 is a flow chart showing an operation of this speech synthesis apparatus. The operation of the speech synthesis apparatus in this embodiment will be described below according to this flow chart.

After starting the operation (S1000), the speech synthesis apparatus obtains the text which is subjected to speech synthesis first (S1001). Next, it judges whether the constraint condition concerning the playback of the synthesized speech of this text is satisfied or not (S1002). Since the first synthesized speech can be played back at an arbitrary timing, it performs speech synthesis processing of the text as it is (S1003), and it starts to play back the generated synthesized speech (S1004).

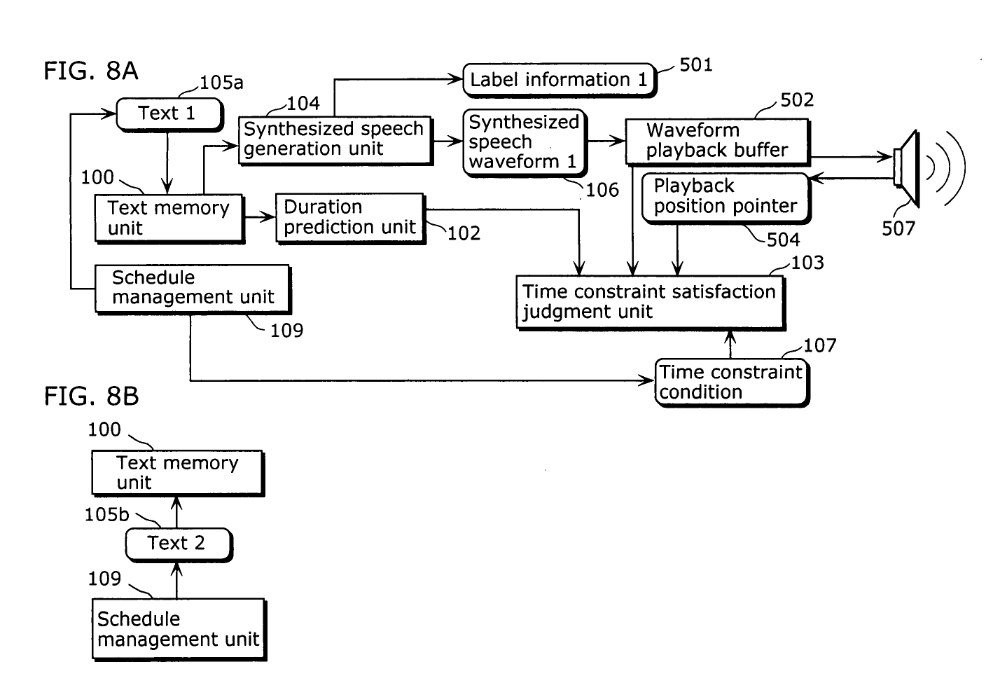

FIG. 8A is an illustration showing a playback state of the synthesized speech of the text 105a inputted first. FIG. 8B is an illustration showing a data flow in the case where the text 105b is provided later. It is assumed that sentences of “Ichi kiro saki de jiko jutai ga ari masu. Sokudo ni ki wo tsuke te kudasai. (There is a traffic congestion 1 km ahead. Please check speed.)” are provided as text 105a, and a sentence of “500 metoru saki, sasetsu shi te kudasai. (Please turn left 500 m ahead.)” is provided as text 105b. In addition, it is assumed that the synthesized speech waveform 106 and the label information 501 have been already generated at the time when the text 105b is provided, and the speaker 507 is playing back the synthesized speech waveform 106 through the waveform playback buffer 502. Further, it is assumed that the condition of “the synthesized speech of the text 105b is played back after the synthesized speech of the text 105a is played back, and the playback of the two units of synthesized speech is completed within 5 seconds” is provided as a time constraint condition 107.

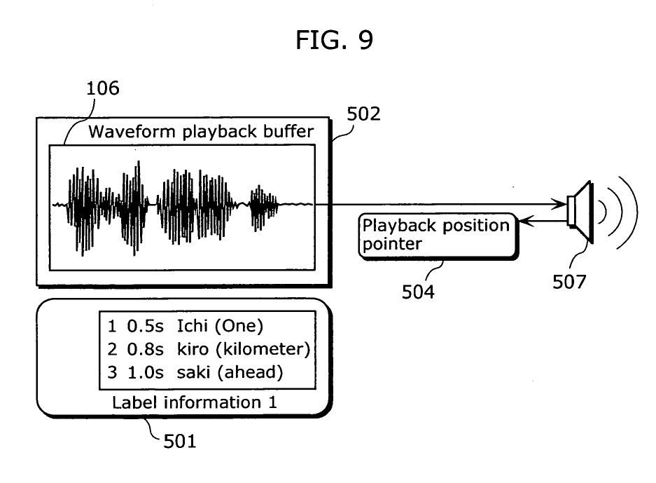

FIG. 9 shows a state of the processing concerning the waveform playback buffer 502 at this time. The synthesized speech waveform 106 is stored in the waveform playback buffer 502, and the speaker 507 is playing it back staring with the starting point of the synthesized speech waveform 106. The playback position pointer 504 includes information indicating the current second, when counted from the start time of the synthesized speech waveform 106, corresponding to the position which is currently played back by the speaker 507. The label information 501 corresponds to the synthesized speech waveform 106. It includes: information indicating the current second, when counted from the start time of the synthesized speech waveform 106, at which each morpheme of the text 105a appears; and information including the appearing order of each morpheme in the text 105a, when counted from the starting morpheme. Here is an example of the synthesized speech waveform. The label information 501 includes: information indicating that the synthesized waveform 106 includes a silent segment of 0.5 second at the starting position; the first morpheme of “1” starts from the position of 0.5 second; the second morpheme of “kiro” starts from the position of 0.8 second; and the third morpheme of “saki” starts from the position of 1.0 second.

In this state, the time constraint satisfaction judgment unit 103 sends an output of “the time constraint condition 107 is not satisfied” to the text connection unit 500 and the content modification unit 101 (S1002). The text connection unit receives this output, and connects the contents of the text 105a and the text 105b so as to generate the connected text 105c (S1005). The content modification unit 101 receives this connected text 105c, and deletes a clause with a low importance in a similar manner to the first embodiment (S1006). The time constraint satisfaction judgment unit 103 judges whether or not the summarized sentence generated in this way satisfies the time constraint condition 107 (S1007). In the case where the time constraint condition 107 is not satisfied, it causes the content modification unit 107 to further summarize the sentence until the time constraint condition 107 is satisfied. After that, it causes the synthesized speech generation unit 104 to perform speech synthesis of the summarized sentence so as to generate a modified synthesized speech waveform 505 and a modified label information 508 (S1008). The read part identification unit 503 identifies the summarized sentence part corresponding to the synthesized speech waveform 106's part which has been played back so far, based on the label information 501 of the synthesized speech which is being played back and the playback position pointer 504 in addition to the label information 508 (S1009).

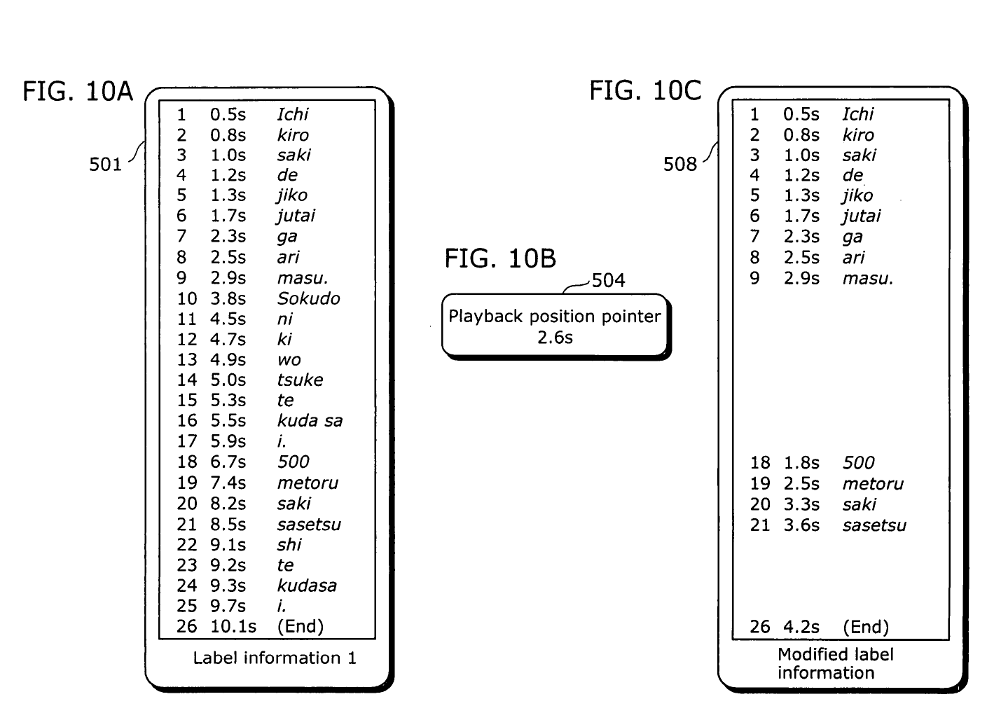

FIG. 10 shows an outline of the processing performed by the read part identification unit 503. FIG. 10A is label information 1 showing an example of connected text. FIG. 10B is a diagram showing an example of a playback completion position shown by the playback position pointer 504. FIG. 10C is a diagram showing an example of modified label information. Here is a case where it is assumed that the text 105c “Ichi kiro saki de jiko jutai ga ari masu. Sokudo ni ki wo tsuke te kudasai. 500 metoru saki, sasetsu shi te kudasai. (There is a traffic congestion 1 km ahead. Please check speed. Please turn left 500 m ahead.)” is summarized as “Ichi kiro saki de jiko jutai ga ari masu. 500 metoru saki, sasetsu. (There is a traffic congestion 1 km ahead. Turn left 500 m ahead.)” by the content modification unit 101, while the played-back part of the text 105c is retained. In this case, comparing the label information 501 with the modified label information 508 shows the played-back summarized sentence part.

In addition, the read part identification unit 503 may ignore the played-back part in the synthesized speech, connect two units of text, summarize them arbitrarily, and start to play back the connected text starting with a summarized sentence positioned after the played-back part. For example, it is assumed that the text 105c is summarized as “Ichi kiro saki jutai. 500 metoru saki, sasetsu. (A traffic congestion 1 km ahead. Turn left 500 m ahead.)”. In FIG. 10B, the playback position pointer 504 shows 2.6 s. Since the position of 2.6 s in the label information 501 is in the middle of the eighth morpheme of “ari”, it is possible to consider that the part of “1 kiro sakijutai.” of the summarized sentence has been already played back.

Based on the information calculated by the read part identification unit 503, the time constraint satisfaction judgment unit 103 judges whether or not the time constraint condition 107 is satisfied. Here, the modified label information 508 shows that the duration of the part, in the summarized sentence, which is not yet to be played back is 2.4 seconds, and the remaining playback duration of the eighth morpheme “ar” in the label information 501 is 0.3 second. Therefore, in the case of replacing the speech waveform after the ninth morpheme by the synthesized speech waveform 505, instead of playing back the speech inside the waveform playback buffer 502 in sequence, the playback of the synthesized speech is completed in 2.7 seconds. The time constraint condition 107 is to complete playback of the contents of the text 105a and 105b within 5 seconds. Therefore, as mentioned above, it is good to overwrite the waveform part of “masu. Sokudo ni ki wo tsuke te kudasai. 500 metoru saki, sasetsu shite kudasai.” inside the waveform playback buffer 502 using the waveform part of “500 metoru saki, sasetsu.” in the summarized sentence which is not yet played back. The unread part exchange unit 506 performs this processing (S1010).

The use of the method described up to this point makes it possible to play back two synthesized speech contents within a limited time without changing the meanings, even in the case where the playback of the second synthesized speech is requested in a state where the first synthesized speech is being played back first.

### Third Embodiment

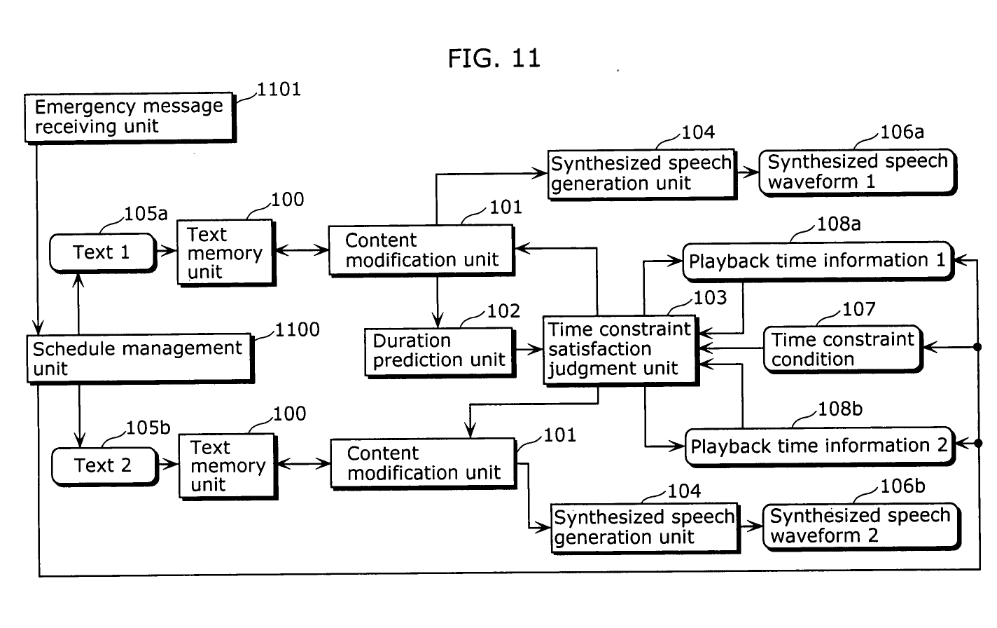

FIG. 11 is a diagram illustrating an operation image of a speech synthesis apparatus of a third embodiment of the present invention.

In this embodiment, the speech synthesis apparatus reads out a schedule according to an instruction by the schedule management unit 1100, and reads out an emergency message which is suddenly inserted by the emergency message receiving unit 1101. The schedule management unit 1100 calls, the schedule information which has been preset in advance through an input by a user and the like at a predetermined time. In addition, it generates text information 105 and a time constraint condition 107 so as to make the synthesized speech be played back. In addition, the emergency message receiving unit 1101 receives the emergency message from another user, sends it to the schedule management unit 1100, and causes it to change the reading-out timing of the schedule information and to insert the emergency message.

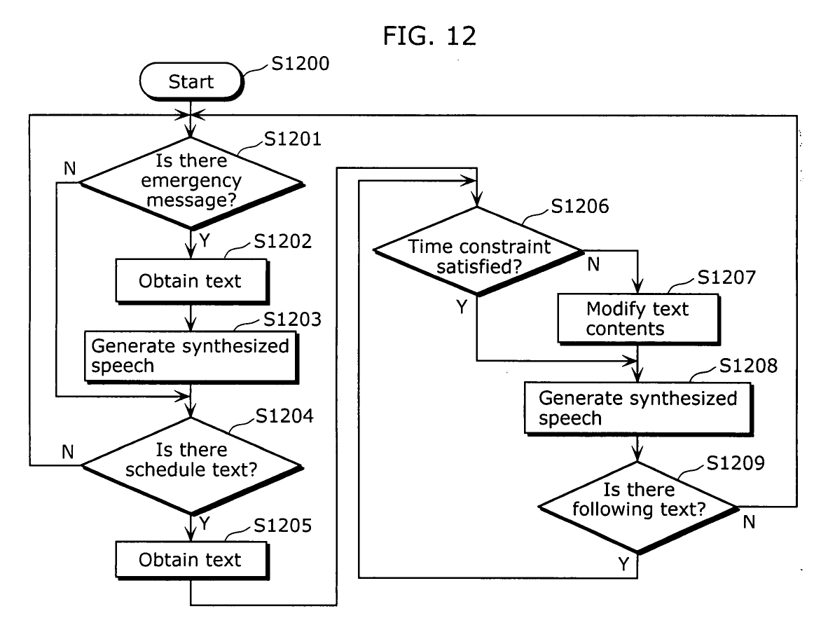

FIG. 12 is a flow chart showing an operation of the speech synthesis apparatus of this embodiment. The speech synthesis apparatus of this embodiment checks whether or not the emergency message receiving unit 1101 has received the emergency message, firstly after the operation is started (S1201). In the case where there is an emergency message, it obtains the emergency message (S1202) and plays it back as synthesized speech (S1203). In the case where the playback of the emergency message is completed or in the case where there is no emergency message, the schedule management unit 1100 checks whether or not there is text of a schedule which needs to be informed immediately (S1204). In the case where there is no emergency message, it returns to a waiting state of an emergency message, but in the case where there is an emergency message, it obtains the schedule text (S1205). There is a possibility that the playback timing of the obtained schedule text is delayed from a scheduled playback timing, due to the playback of the emergency message which has been inserted. Hence, whether the constraint concerning the playback time is satisfied or not is judged (S1206). In the case where the constraint is not satisfied, it performs content modification of the schedule text (S1207). For example, in the case where the reading-out start time of the text of “5 fun go ni miiting ga hajimari masu. (The meeting will start 5 minutes later.)” is delayed by 3 minutes from the scheduled reading-out time due to the reading-out of the emergency message, it modifies the text into the text of “2 fun go ni miiting ga hajimari masu. (The meeting will start 2 minutes later.)” and performs speech synthesis processing of the modified text (S1208). Subsequently, it judges whether there is following text or not (S1209). In the case where there is such text, it continues the speech synthesis processing by repeating the processes from a judgment as to whether a constraint is satisfied or not.

The speech synthesis apparatus informs the user of speech schedule using the method described up to this point. Additionally, in the case where it receives an emergency message from another user, it reads out the emergency message also. There is an effect that it can reflect the timing shift to the text of a schedule whose information is to be provided at a delayed timing due to the reading-out of the emergency message. More specifically, there is an effect that it can read out the text correcting the text contents indicating time and distance by the reading-out timing shift.

Note that each function block of the block diagrams (FIG. 1, 6, 8, 11 and the like) is typically realized as an LSI which is an integrated circuit. Each function block may be configured as an independent chip, and some or all of these function blocks may be integrated into a single chip.

(For example, the function blocks other than the memory may be integrated into a single chip.)

Here, the integrated circuit realizing each function block is called LSI. However, such LSI may be called as an IC, a system LSI, a super LSI or an ultra LSI, depending on the integration degree.

An integrated circuit is not necessarily realized in a configuration of an LSI, it may be realized in a form of an exclusive circuit or a general purpose processor. It is also possible to use the Field Programmable Gate Array (FPGA) that enables programming or a reconfigurable processor that can reconfigure the connection or settings of a circuit cell inside the LSI, after generating an LSI.

Further, in the case where technique of realizing an integrated circuit that supersedes the LSI is invented along with the development in semiconductor technique or another derivative technique. As a matter of course, integration of the function blocks may be realized using the invented technique. Bio technique is likely to be adapted.

In addition, the unit which stores data to be coded or decoded among the respective function blocks may be independently configured without being integrated into a chip.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is used for applications where information is provided in real time using speech synthesis technique. The present invention, in particular, is especially useful for applications where it is difficult to schedule in advance a playback timing of synthesized speech. Such applications include a car navigation system, a news distribution using synthesized speech, a scheduler which manages schedules using a Personal Digital Assistant (PDA) or a personal computer.

What is claimed is:

1. A speech synthesis method comprising:
predicting a playback duration of synthesized speech to be generated based on text;
judging whether a constraint condition concerning a playback timing of the synthesized speech is satisfied or not, based on the predicted playback duration;
in the case where said judging shows that the constraint condition is not satisfied,
shifting a playback starting timing of the synthesized speech of the text forward or backward, and modifying contents indicating time or distance in the text, in accordance with a duration by which the playback starting timing of the synthesized speech is shifted; and
generating synthesized speech based on the text with the modified contents, and playing back the synthesized speech.

2. The speech synthesis method according to claim 1, wherein:
in the case where there are plural units of speech, said predicting includes predicting a playback duration of second synthesized speech, playback of the second synthesized speech needing to be completed before playback of first synthesized speech starts;
said judging includes judging that the constraint condition is not satisfied, in the case where the predicted playback duration of the second synthesized speech indicates that the playback of the second synthesized speech is not completed before the playback of the first synthesized speech starts;
said shifting includes delaying a playback starting timing of the first synthesized speech to a predicted playback completion time of the second synthesized speech, and said modifying includes modifying the contents of text based on which the first synthesized speech is generated, said shifting and modifying being performed in the case where said judging shows that the constraint condition is not satisfied; and
said generating includes generating synthesized speech based on the text with the modified contents and playing back the synthesized speech, after completing the playback of the second synthesized speech.

3. The speech synthesis method according to claim 2, wherein
said modifying further includes reducing the playback duration of the second synthesized speech by summarizing the text based on which the second synthesized speech is generated, and delaying the playback starting timing of the first synthesized speech to a time at which the playback of the second synthesized speech with the reduced playback duration is completed.

4. The speech synthesis method according to claim 1, wherein:
said predicting includes predicting a playback duration of synthesized speech, the playback of the synthesized speech needing to be completed by a preset time;
said judging includes judging that the constraint condition is not satisfied, in the case where the predicted playback duration of the synthesized speech indicates that the playback of the second synthesized speech is not completed by the preset time;
said shifting includes delaying the playback starting timing of the synthesized speech by a duration starting from the preset time indicated in the text based on which the synthesized speech is generated, and said modifying includes modifying the preset time in accordance with the duration by which the playback starting timing of the synthesized speech is delayed, said shifting and modifying being performed in the case where said judging shows that the constraint condition is not satisfied; and
said generating includes generating synthesized speech based on the text with the modified contents and playing back the synthesized speech.

5. An information providing apparatus comprising:
a duration prediction unit operable to predict a playback duration of synthesized speech to be generated based on text;
a time constraint satisfaction judgment unit operable to judge whether a constraint condition concerning a playback timing of the synthesized speech is satisfied or not, based on the predicted playback duration;
a content modification unit operable to shift a playback starting timing of the synthesized speech of the text forward or backward, and modify contents indicating time or distance in the text, in accordance with a duration by which the playback starting timing of the synthesized speech is shifted, in the case where said time constraint satisfaction judgment unit judges that the constraint condition is not satisfied; and
a synthesized speech generation unit operable to generate synthesized speech based on the text with the modified contents, and play back the synthesized speech.

6. The information providing apparatus according to claim 5, wherein:
said information providing apparatus is operable to function as a car navigation apparatus which provides a speech guidance concerning a route to a destination;
said information providing apparatus further includes a speed obtainment unit operable to obtain a moving speed of a car;
said duration prediction unit is operable to predict a playback duration of a second synthesized speech, the playback of the second synthesized speech needing to be completed before playback of a first synthesized speech is started;
said time constraint satisfaction judgment unit is operable to judge that the constraint condition is not satisfied, in the case where the predicted playback duration of the second synthesized speech indicates that the playback of the second synthesized speech is not completed before the playback of the first synthesized speech starts;
said content modification unit is operable to delay a playback starting timing of the first synthesized speech to a predicted time at which the playback of the second synthesized speech is completed, and modify a distance to a predetermined location in accordance with a moving distance corresponding to the delay of the playback starting timing of the first synthesized speech, in the case where said time constraint satisfaction judgment unit judges that the constraint condition is not satisfied, the predetermined location being indicated in the text based on which the first synthesized speech is generated and the moving distance being calculated from the moving speed obtained by said speed obtainment unit; and
said synthesized speech generation unit is operable to generate the first synthesized speech based on the text with the modified contents and play back the first synthesized speech, after completing the playback of the second synthesized speech.

7. The information providing apparatus according to claim 5, wherein:
said information providing apparatus is operable to function as a scheduler which reads out a schedule registered by a user using synthesized speech at a preset time which is before a start time of the schedule;
said information providing apparatus further includes a registration unit operable to accept registration of the user's schedule, the start time of the schedule and the preset time;
said duration prediction unit is operable to predict a playback duration of synthesized speech, the playback of the synthesized speech needing to be played back by the preset time;
said time constraint satisfaction judgment unit is operable to judge that the constraint condition is not satisfied, in the case where the predicted playback duration of the synthesized speech indicates that the playback of the synthesized speech is not completed by the preset time;
said content modification unit is operable to delay a playback starting timing of the synthesized speech to a time which is earlier than the start time of the schedule, and modify a duration before the start time of the schedule in accordance with the duration by which the playback starting timing of the synthesized speech is delayed, in the case where said time constraint satisfaction judgment unit judges that the constraint condition is not satisfied, the time to be modified being indicated in the text based on which the synthesized speech is generated; and
said synthesized speech generation unit is operable to generate synthesized speech based on the text with the modified contents and play back the synthesized speech.

8. A program intended for an information providing apparatus, said program causing a computer to execute:
predicting a playback duration of synthesized speech to be generated based on text;
judging whether a constraint condition concerning a playback timing of the synthesized speech is satisfied or not, based on the predicted playback duration;
in the case where said judging shows that the constraint condition is not satisfied, shifting a playback starting timing of the synthesized speech of the text forward or backward, and modifying contents indicating time or distance in the text, in accordance with a duration by which the playback starting timing of the synthesized speech is shifted; and
generating synthesized speech based on the text with the modified contents, and playing back the synthesized speech.
